(19) United States
(12) Patent Application Publication
(10) Pub. No.: US 2008/0134285 A1
(43) Pub. Date: Jun. 5, 2008

(54) APPARATUS AND METHOD FOR COUNTERING SPAM IN NETWORK FOR PROVIDING IP MULTIMEDIA SERVICE

(75) Inventors: Eun Sook Kim, Daejeon (KR); So Yung Park, Daejeon (KR); Shin Gak Kang, Daejeon (KR)

Correspondence Address: RABIN & Berdo, PC, 1101 14TH STREET, NW, SUITE 500, WASHINGTON, DC, 20005, US

(73) Assignee: Electronics and Telecommunications Research Institute, Daejeon (KR)

(21) Appl. No.: 11/932,660

(22) Filed: Oct. 31, 2007

(30) Foreign Application Priority Data
Dec. 4, 2006 (KR) 10-2006-0121833
Jul. 19, 2007 (KR) 10-2007-0072384

(51) Int. Cl. G06F 17/00

(52) U.S. Cl. 726/1

(57) ABSTRACT

It is possible to filter spam of diversified Internet protocol (IP) multimedia applications, since it is possible to provide spam filtering services suitable for various processing methods of calls of the IP multimedia applications and media features in an application server layer without changing a structure of IP multimedia service network by classifying calls of IP multimedia application services based on service features, checking policy information of the calls classified based on the service features, filtering spam so as to determine whether the call is spam through dynamic filtering mechanism for each application service, and transmitting the call to a lower network by determining a suitable processing method based on the checking result of the policy information or the filtering result, so as to filter IP multimedia spam in an application server in a network for providing various real-time IP multimedia application services.

### CROSS-REFERENCE TO RELATED APPLICATIONS

This application claims the priority of Korean Patent Application No. 10-2006-121833 filed on Dec. 4, 2006 and No. 10-2007-72384 filed on Jul. 19, 2007, in the Korean Intellectual Property Office, the disclosure of which is incorporated herein by reference.

### BACKGROUND OF THE INVENTION

1. Field of the Invention

The present invention relates to an Internet protocol (IP) multimedia service, and more particularly, to an apparatus and method for countering spam of IP multimedia application in a network for providing an IP multimedia service.

This work was supported by the IT R&D program of MIC/IITA [2006-P10-43, Study on standardization of public of public safety for IP application service]

2. Description of the Related Art

Recently, emerging Internet protocol (IP) multimedia applications such as instance messaging and voice-over-Internet protocol (VoIP) services have been rapidly replaced existing communication means. These IP multimedia applications are under a threat of attacks such as spam. In general, the spam denotes, for example, an unsolicited commercial e-mail. The spam may include an unsolicited message or call to new IP multimedia applications as well as the aforementioned e-mail spam. The spam to the new applications may be separately referred to as spam for instance messaging (SPIM) and spam for Internet telephony (SPIT). Sometimes, the SPIT may be referred to as a voice or VoIP spam (VAM).

All the real-time IP multimedia application services have to filter spam in various manners based on features of the real-time IP multimedia application services.

The SPIM is similar to e-mail spam in contents, a deceitful title line, a counterfeit transmitter name, and the like. However, since the instance messaging service is a real-time service, it is impossible to apply an e-mail spam technique for processing mails stored in a server to a filtering process of the SPIM as it is. Accordingly, in a conventional technique, spam is detected and extracted by using a method of searching an address line and a method of searching contents, like e-mail spam.

Unlike the SPIM, it is difficult to detect the SPIT by searching voice of an Internet phone, and a subject of a title line and contents of a video message. It is possible to recognize the SPIT, when a call is established. Thus, in case of the Internet phone, a service provider enables all the commercial calls to display caller identification as one of anti-spam policies so as to allow an address to be filtered. A method of introducing an authentication key in all the transmitter/receiver may be employed.

Up to now, since a threat to the real-time IP multimedia application services is regarded to be less serious than e-mail spam or mobile phone spam, a method of filtering this latent threat is not actively researched.

On the other hand, in a network for providing the IP multimedia application service, application servers such as an instance messaging server, a presence server, and a VoIP proxy server serve to connect and distribute a call to a core Internet network so as to connect user terminals to one another.

However, many service providers use a method of sharing and distributing resources with a core stack for the corresponding service by operating a united application server for these application. This service may be finally mapped into a system located at an application server layer of an IP multimedia subsystem (IMS) platform. Thus, it is necessary to establish an application server system equipped with a system for countering spam of IP multimedia applications.

### SUMMARY OF THE INVENTION

An aspect of the present invention provides an Internet protocol (IP) multimedia server network for providing a countering spam mechanism for a real-time IP multimedia application, in consideration of providing of an IP multimedia service of the current Internet and development of the next generation Internet.

An aspect of the present invention also provides an apparatus and method for countering spam by establishing an extended IP multimedia application server that is applicable regardless of application steps or a service type of a lower level network by dynamically countering spam suitable for each feature and easily providing transplantable modules in a network for providing a real-time IP multimedia application service.

According to an aspect of the present invention, there is provided an apparatus for countering spam in a network for providing an IP multimedia service, the apparatus comprising: a service broker classifying according to application services all the calls incoming into an application server end of the network for providing various real-time IP multimedia services; a countering spam controller managing security by exchanging a policy and database information differently applied based on the application services and determining whether all the incoming calls classified by the service broker based on the application services are spam; a policy and database (DB) management interface managing policy information for each application service, database information, and a filtering method determined to be applied for the each application service and transmitting a policy to be applied to the spam countering controller in response to a request of the spam countering controller; and a resource manager managing resources needed for the spam filtering controller.

According to another aspect of the present invention, there is provided a method for countering spam in an application server in a network for providing various real-time IP multimedia application services, the method comprising: classifying calls of IP multimedia application services based on service features; checking policy information of the calls classified based on the service features; filtering spam so as to determine whether the call is spam through dynamic filtering mechanism for each application service; and transmitting the call to a lower network by determining a suitable processing method based on the checking result of the policy information or the filtering result.

As described above, in the present invention, it is possible to countering spam of diversified IP multimedia applications by providing countering spam services suitable for various processing methods of calls of the IP multimedia applications and media features in an application server layer without changing a structure of IP multimedia service network in a current Internet and the next generation IP multimedia subsystem (IMS) platform.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 illustrates a structure of a network for providing an Internet protocol (IP) multimedia service;

FIG. 2 illustrates a structure of an application server system for countering spam according to an embodiment of the present invention;

FIGS. 3 and 4 illustrate states in which information is communicated so as to keep a security of an application server and to manage a filter in the application server according to an embodiment of the present invention;

FIG. 5 illustrates an operation for countering spam in a security manager shown in FIG. 2; and

FIG. 6 illustrates an operation for filtering an IP multimedia spam in a filter manager shown in FIG. 2.

### DETAILED DESCRIPTION OF THE PREFERRED EMBODIMENT

Exemplary embodiments of the present invention will now be described in detail with reference to the accompanying drawings. When it is determined that the detailed descriptions of the known techniques or structures related to the present invention depart from the scope of the invention, the detailed descriptions will be omitted.

In an embodiment of the present invention, an application server end for receiving a request for a service from a user and processing the service in a network for providing a real time Internet protocol (IP) multimedia service suitably countering spam based on service features by dynamically operating a countering spam policy and mechanism suitable for the feature of the IP multimedia application. That is, since settings of a call and media features are changed based on application services such as voice-over-Internet protocol (VoIP), instance messaging (IM) and presence, and IP conference services. It is necessary to provide countering spam policy and mechanism suitable for features of each application service.

In an embodiment of the present invention, functions designed for modules in the IP multimedia application server don't need to be embodied in a single system. A method of embodying the functions is not limited thereto. In addition, detailed description on known functions such as a function of a call/message control element, a resource management function, and a function of processing a lower lever network interface will be omitted. They are only used to show the relationship with the ‘countering spam control unit.’

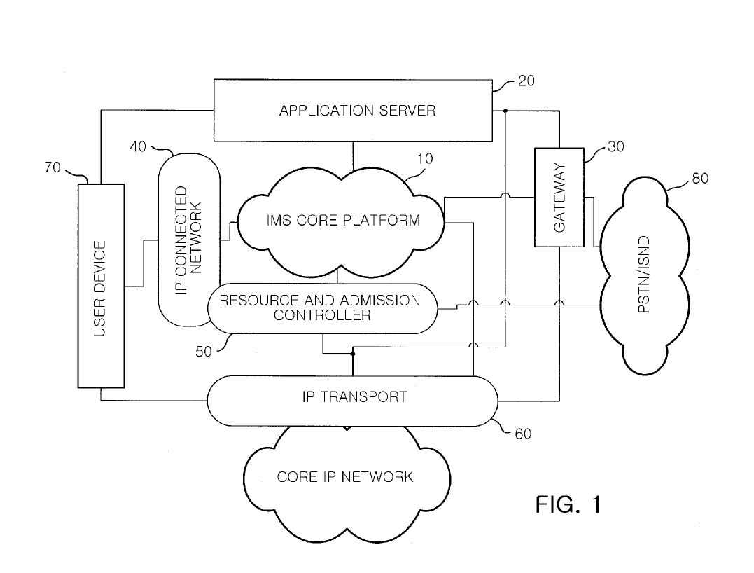

FIG. 1 illustrates a structure of a network for providing an IP multimedia service.

Referring to FIG. 1, the network for providing the IP multimedia service includes a plurality of application servers 20 linked through an IP multimedia subsystem (IMS) core platform 10, IP connected network 40, a resource and admission controller 50, and an IP transport 60. A user device 70 is connected between the application server 20 and the IP connected network 40. Here, a gateway 30 is connected to a public switched telephone network/securing Cisco network devices (PSTN/SND) 80. The IP transport 60 is connected to a core IP network 90. The structure of the network for providing the multimedia service may be applied to all the next generation IMS platforms, in addition to the existing Internet.

The plurality of application servers 20 are connected to a core network such as the Internet or IMS platform so as to provide network resources to an application terminal. The plurality of application servers 20 provide various application services such as instance messaging and VoIP services to user terminals at both ends thereof through an instance messaging server, a presence server, and a proxy server. The application servers 20 serve to filter IP multimedia spam. The application servers 20 are extended to application servers for dynamically filtering spam suitably for features of each real-time IP multimedia application, such as VoIP, instance messaging (IM), presence, and IP conference services, which replaces the PSTN.

Then, the application servers for filtering the IP multimedia spam will be described in detail with reference to accompanying drawings.

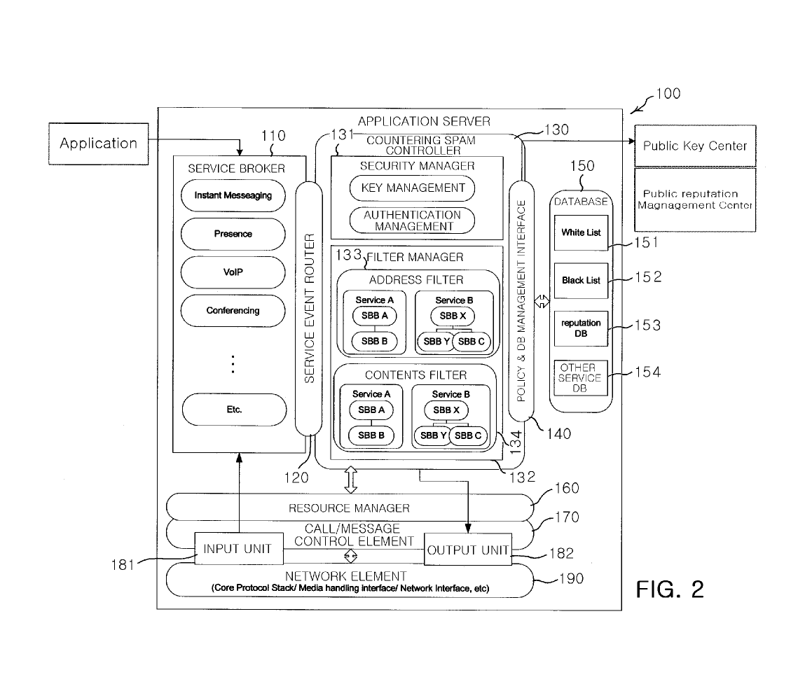

FIG. 2 illustrates a structure of an application server system for countering spam according to an embodiment of the present invention.

Referring to FIG. 2, the application server may be constructed with a service broker 110, a service event router 120, a countering spam controller 130, a policy and DB management interface 140, a database 150, a resource manager 160, an input/output unit 181 and 182, a call/message control element unit 170, and a network element unit 190. The IP multimedia application server may concurrently provide various services.

The service broker 110 classifies input application services and receives information on each element (a core protocol stack, a medium handling interface, a network interface, and the like) of the network element unit 190 through the input unit 181. Here, the distributed application services include instance messaging, presence, VoIP, and conference services.

The countering spam controller 130 receives the classified application service through the service event router 120, exchanges policies and database information, which are differently applied based on the application services, with the policy and DB management interface 140, and performs security management. The countering spam controller 130 determines whether an incoming call is spam based on features of services by distinguishing a call to be safely transmitted from a call to be filtered and transmits the call to a call/message control element unit 170 through the output unit 182.

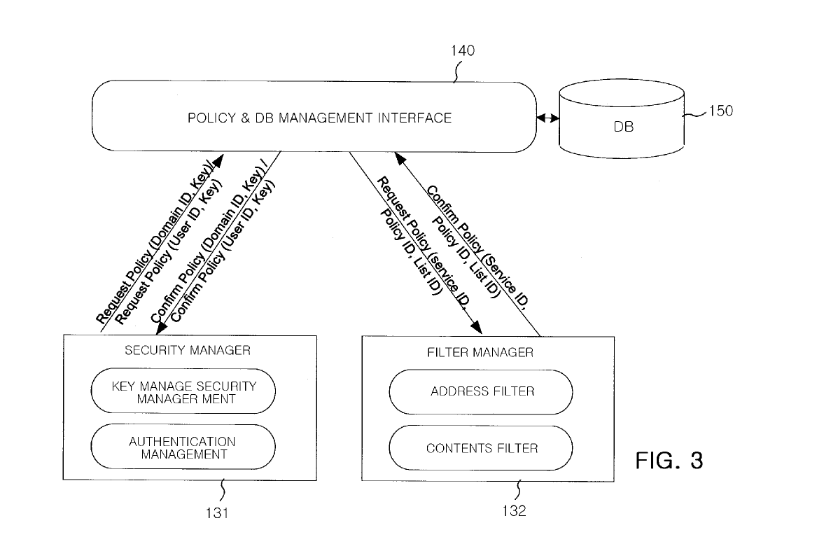

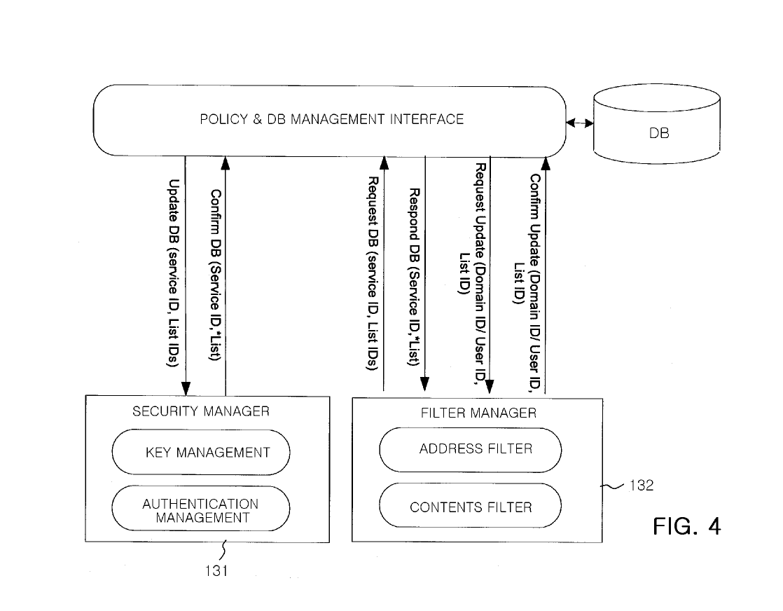

The policy and DB management interface 140 manages security and authentication policy information for each service and performs communication with an external public key center, if necessary. The policy and DB management interface 140 manages policy information on a filtering method (dynamic filtering mechanism, etc) determined to be applied based on services by the service provider, in addition to a key policy. That is, the policy and DB management interface 140 allows DB update information to be exchanged between the countering spam controller 130 and the database 150. This will be described again with reference to FIGS. 3 and 4.

The database 150 includes a white list 151, a black list 152, a reputation DB 153, and other service DB 154.

The resource manager 160 manages network resources and transmits/receives necessary resources in linkage with the countering spam controller 130.

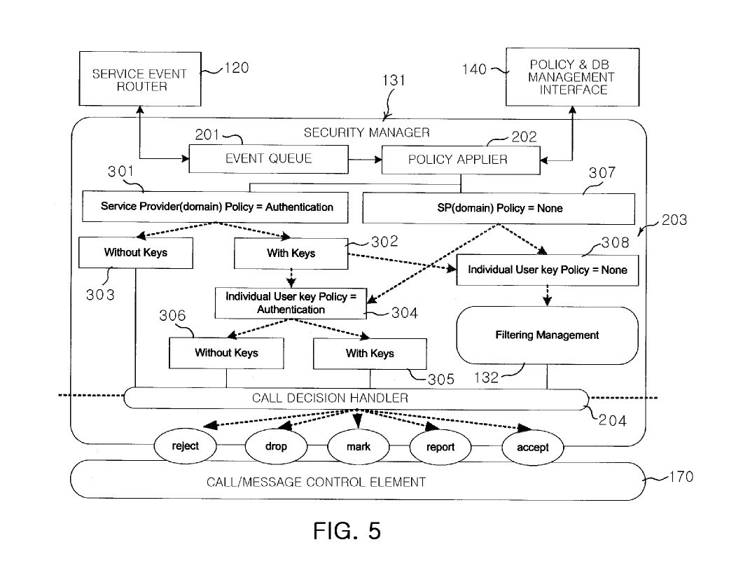

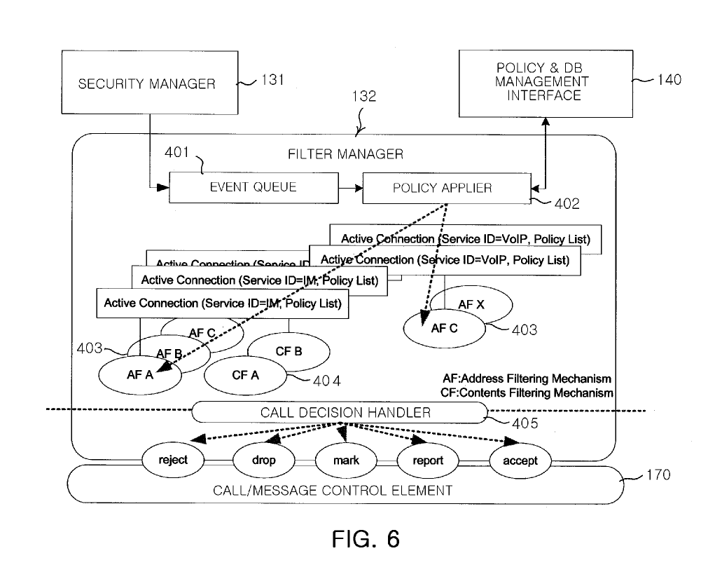

On the other hand, the countering spam controller 130 is constructed with a security manager 131 and a filter manager 132. In order to determine whether an incoming call is spam, the filter manager 132 operates by including modules such as an address filter 133 and a contents filter 134. The detailed structures of the security manager 131 and the filter manager 132 for countering spam will be described with reference to the accompanying FIGS. 5 and 6.

Referring to FIG. 5, the security manager 131 may be constructed with an event queue 201 receiving a call classified based on services from the service event router 120, a policy applier 202 requesting the policy and DB management interface 140 to provide policy information and mechanisms and receiving the policy information and the mechanisms from the policy and DB management interface 140, a checker 203, and a call decision handler 204. The security manager 131 checks a key and authentication information with respect to the received call by using the received policy information. Here, the checker 203 checks whether the received policy information and the mechanisms include an authentication key policy. When the policy information and the mechanisms include the authentication key policy, it is checked whether the policy information and the mechanisms includes a key policy for each user. The call decision handler 204 transmits the call to the call/message control element unit 170 by separately processing the call based on the check result.

Referring to FIG. 6, the filter manager 132 may be constructed with an event queue receiving a call not including policy information from the security manager 131, a policy applier 402 calling a corresponding filtering mechanism from the policy and DB management interface 140, an address filter 403 filtering spam by searching for the address and contents of the call not including the policy information by using the called filtering mechanism, and a contents filter 404. The filter manager 132 includes a call decision handler 405 transmitting the call to the call/message control element unit 170 by separately processing the call.

Operations for exchanging information obtained by allowing the security manager 131 and the filter manager 132 included in the countering spam controller 130 to exchange policies with the policy and DB management interface 140 and information on DB updating will be described with reference to FIGS. 3 and 4.

Referring to FIG. 3, the security manager 131 transmits a request message for requesting the policy and DB management interface 140 to provide the policy information of the call Request Policy (Domain ID, Key)/(User ID, Key). Accordingly, the security manager 131 checks a key and authentication information with respect to the received call by receiving a response message Confirm Policy including the requested policy information (Domain ID, Key)/(User ID, Key) from the policy and DB management interface 140. In addition, the filter manager 132 receives a request for a policy from the policy and DB management interface 140, receives a service ID, a policy ID, and a list ID of the incoming call, and drives the corresponding mechanism. The filter manager 132 transmits the response Confirm Policy to the policy and DB management interface 140.

Referring to FIG. 4, the security manager 131 of the countering spam controller 130 exchanges information (service ID, list IDs, and the like) on DB updating with the policy and DB management interface 140. The filter manager 132 exchanges information (Domain ID/User ID, List ID, and the like) on DB updating with the policy and DB management interface 140. In the procedure of exchanging and processing information, DB update such as registration of spammer and registration of a new value in a reputation DB 153 is necessary. Accordingly, a DB value for each service ID and a value changed for each ID according to a policy may occur. The changed value is reflected by communicating with the policy and DB management interface 140.

Operations of the security manager 131 and the filter manager 132 in the countering spam controller 130 will be described in detail with reference to the accompanying drawings.

FIG. 5 illustrates an operation for countering spam in a security manager shown in FIG. 2.

First, in order to check whether there is a security policy applied by a service provider, all the incoming calls are transmitted to the security manager 131.

Accordingly, referring to FIG. 5, the event queue 201 of the security manager 131 receives a call from the service event router 120 and generates an event on the call to the policy applier 202. The policy applier 202 receives policy information through a response message by transmitting policy request message to the policy and DB management interface 140.

Then, the checker 203 of the security manager 203 checks whether the received policy information includes an authentication key policy by authenticating all the incoming calls that are input in operations 301 to 303 based on domains of service providers. As in operation 302, when the received policy information includes the authentication key policy, it is further checked in operations 304 to 306 whether the received policy information includes a user key policy.

Then, in a case where the authentication policy has to be reflected, the security manager 131 checks whether a suitable key value and other authentication information are included in the received policy information and transmits the call to the call/message control element unit 170 so as to suitably process the call by selecting a suitable process from among reject, drop, mark, report, and accept processes through the decision handler 204.

Like operation 307, when a domain authentication key policy is not included in the received policy information, the security manager 131 returns to operation 304 and checks whether only the user key policy is applicable. After operations 302 and 307, as in operation 308, the checker 203 checks whether the user key policy is included in the received policy information. When there is no specific authentication policy, the checker 203 transmits the incoming call to the filter manager 132 for searching for an address and contents so as to check whether the received call is spam.

Next, a procedure of dynamically applying a policy based on services by the filter manager included in the countering spam controller will be described.

FIG. 6 illustrates an operation for countering spam in a filter manager shown in FIG. 2.

Referring to FIG. 6, a dynamic thread operates based on services with respect to each call transmitted to the event queue through the security manager 131. Accordingly, when an event for each call transmitted from the event queue 301 is generated, the policy applier 302 calls a filtering mechanism suitable for the service for the policy and DB management interface 140 and receives the filtering mechanism. The address filter 403 of the security manager 131 filters spam by using the received filtering mechanism by searching for an address of a call not including the policy information. The contents filter 404 filters spam by using the received filtering mechanism and the called filtering mechanism by searching for contents of the call not including the policy information. That is, an instance messaging (IM) service is basically constructed with a buddy list so as to manage a policy of a white list 151. Since it is possible to filter spam by searching for a key word of a title line and contents, these filtering mechanisms are dynamically applicable based on services. On the other hand, in case of the Internet telephone service, since it is impossible to filter spam through a current technique, it is possible to apply an address filtering method to the Internet telephone service. The embodiment of the present invention is not limited to a specific filtering mechanism. The embodiment of the present invention provides an operation of a system based on a policy of dynamically applying filtering mechanisms according to services.

As in the security manager 131, all the calls passing through filtering mechanisms based on the filtering policy are classified into reject, drop, mark, report, and accept and transmitted to a call/message control element so as to suitably process the call.

As described above, the present invention provides an application server system including a countering spam policy and mechanism suitable for various call settings and media features to IP multimedia applications. Although IP multimedia application service are diversified and media characteristics are changed, it is possible to easily extend a countering spam control unit constructed with modules according to an embodiment of the present invention so as to provide spam filtering mechanisms for various applications through interface between a service broker and a countering spam controller.

In addition, it is possible to change and extend a detailed mechanism regardless of other services, since various mechanisms are dynamically called so as to operate in the modulated security manager and filter manager.

While the present invention has been shown and described in connection with the exemplary embodiments, it will be apparent to those skilled in the art that modifications and variations can be made without departing from the spirit and scope of the invention as defined by the appended claims.

What is claimed is:

1. An apparatus for countering IP (Internet protocol) multimedia spam in a network for providing an IP multimedia service, the apparatus comprising:
a countering spam controller managing security by exchanging a policy and database information differently applied based on a application services and determining whether all the incoming calls classified by a service broker are spam;
a policy and DB (database) management interface managing policy information for each application service, database information, and a filtering method determined to be applied for the each application service and transmitting a policy to be applied to the countering spam controller in response to a request of the countering spam controller; and
a resource manager managing resources needed for the spam filtering controller.

2. The apparatus of claim 1, further comprising:
an input/output unit transmitting network elements to the service broker and transmitting the classified calls by calls determined whether to be spam or not and classifying by the countering spam controller, to a call/message control element unit;
a service event router transmitting the calls classified by the service broker to the countering spam controller; and
a database storing information on the determination result obtained by the countering spam controller through the policy and DB (database) management interface.

3. The apparatus of claim 1, wherein the countering spam controller includes:
a security manager receiving a call classified based on the services through the service event router, requesting provide policy information of the received call to the policy and DB management interface, and checking a key and authentication information for the received call by using the received policy information; and
a filter manager countering spam by searching for an address and contents of the received call, when there is no policy information of the received call.

4. The apparatus of claim 3, wherein the security manager includes:
an event queue receiving a call classified based on the services through the service event router;
a policy applier receiving policy information from the policy and DB management interface;
a checker checking whether the received policy information includes an authentication key policy for each domain of a service provider and checking whether the received policy information includes a key policy for each user when the received policy information includes the authentication key policy for each domain; and
a call decision handler transmitting the call to the call/message control element by determining a processing method of the call based on the check result by the checker.

5. The apparatus of claim 3, wherein the filter manager includes:
an event queue receiving a call not including policy information from the security manager;
a policy applier calling a filtering mechanism from the policy and DB management interface;
an address filter searching for an address of the call not including the policy information by using the called filtering mechanism;
a contents filter searching for contents of the call not including the policy information by using the called filtering mechanism; and
a call decision handler transmitting the call not including the policy information by determining a processing method of the call based on the filtering result obtained by the address filter and the contents filter.

6. A method for countering IP (Internet protocol) multimedia spam in an application server in a network for providing various real-time IP multimedia application services, the method comprising:
classifying calls of IP multimedia application services based on service features;
checking policy information of the calls classified based on the service features;
filtering spam so as to determine whether the call is spam through dynamic filtering mechanism for each application service; and
transmitting the call to a lower network by determining a suitable processing method based on the checking result of the policy information or the filtering result.

7. The method of claim 6, further comprising exchanging information on updating of a database based on the checking of the policy information and the filtering of spam.

8. The method of claim 6, wherein the checking of the policy information of the calls classified based on service features comprises:
requesting the policy and DB management interface to provide the policy information, when receiving the calls classified based on the service features;
checking whether the policy information received in response to the request includes an authentication key policy for each domain of a service provider;
checking whether the policy information includes a key policy for each user, when the policy information includes the authentication key policy for each domain; and
transmitting the received call to a call/message control element by determining a processing method of the call based on the check result of the key policy for each user.

9. The method of claim 8, further comprising transmitting the received call to a filter manager for checking whether the received call is spam, when the policy information does not include the authentication key policy for each domain.

10. The method of claim 6, wherein the performing of the filtering process for checking whether the call is spam through a dynamic filtering mechanism for each application service comprises:
receiving a call not including the policy information;
calling a filtering mechanism of the received call;
filtering spam by searching for an address and contents of the received call by using the called filtering mechanism; and
transmitting the received call to a call/message control element by determining a method of processing the call based on the result of filtering the spam.
